(19) United States
(12) Patent Application Publication
(10) Pub. No.: US 2001/0029468 A1
(43) Pub. Date: Oct. 11, 2001

(54) Information communication system and information terminal device capable of collecting customer use information

(76) Inventors: Tomohisa Yamaguchi, Nara-ken (JP); Toshimi Kiyohara, Souraku-gun (JP)

Correspondence Address: BIRCH STEWART KOLASCH & BIRCH, PO BOX 747, FALLS CHURCH, VA, 22040-0747, US

(21) Appl. No.: 09/826,822

(22) Filed: Apr. 6, 2001

(30) Foreign Application Priority Data
Apr. 7, 2000 (JP) 2000-106445

(51) Int. Cl. G06F 17/60

(52) U.S. Cl. 705/14

(57) ABSTRACT

Use information generated upon presentation of an advertisement is fed back to an advertisement providing source. An advertisement presenting unit in an information terminal device displays an advertisement and a display transition button in part of a displayed image on a display device. When a user operates the button, an advertisement using unit detects and stores advertisement use information in an advertisement use information storing unit and the advertisement presenting unit displays detailed information. An advertisement use information sending unit sends the accumulated advertisement use information to an advertisement use information receiving unit so as to be collected in an advertisement use information collecting unit. An advertisement use information analyzing unit analyzes the collected advertisement use information, determines advertisement information to be supplied and reads the information from an advertisement information saving unit. An advertisement information supplying unit sends the read advertisement information to the information terminal device.

### BACKGROUND OF THE INVENTION

The present invention relates to an information communication system and an information terminal device which are connected to a telecommunication network such as the Internet or the like for searching for information and receiving a supply of information and a program recording medium for recording an advertisement information presenting and advertisement use information collecting program.

With development of telecommunication networks in recent years, telecommunication networks represented by the Internet are widely used in academic activities and business situations and utilization thereof is being regarded as a matter of course. Furthermore, due to a wide spread of radiocommunication terminals such as a PHS (Personal Handy phone System) terminal and the like and a higher transmission speed in data communication using a portable information terminal utilizing these radiocommunication terminals, information on a telecommunication network can be accessed from anywhere at any time. Since portable phones are spread among general users, various electronic information is readily provided to a user through various services provided on the portable phone as in the case of using the Internet.

Thus, telecommunication networks enabling easy access to various information and portable phones and portable information terminals which can be used anywhere at any time have a high value as information media. Furthermore, when information is provided to a user terminal, an advertising effect is made by adding advertisement/publicity information thereto.

In utilization of the aforementioned telecommunication networks, it is required to use these networks at as low cost as possible. In utilization of a radiocommunication line, in particular, this requirement is strong since one line utility charge is high as compared with a case where a general public line is used by cable. Therefore, it is inevitable in utilization of radiocommunication lines that a terminal is not connected to a telecommunication network at all times, but intermittently connected to the network to receive a necessary service. When the telecommunication network is utilized in this way, an advertising effect can be obtained only during the extremely short period of connection even if advertisement/publicity information is added to information provided from the telecommunication network and provided to a user terminal.

To obtain a greater advertising effect under such circumstances, Japanese Patent Laid-Open Publication No. Hei 9-163352 proposes the following method. An information communication terminal acquires advertisement information from a server device in advance while the terminal is being connected to a telecommunication network and stores the information. Then, the stored advertisement is presented to a user during a wait time for connection or the like. Thus, an advertising effect is obtained with a reduced communication cost. Furthermore, in Japanese Patent Laid-Open Publication No. Hei 11-338809, a supply of an advertisement to a user is controlled to control an advertising effect by adding information such as an effective period or the like to the stored advertisement.

In the conventional advertisement service to an information communication terminal via a telecommunication network, a communication cost can be reduced and an advertising effect can be controlled to some extent. However, advertisement information is only utilized for publication and advertisement, but a user operation indicating that the user viewed an advertisement cannot be used at all. For example, in the aforementioned Japanese Patent Laid-Open Publication No. Hei 11-338809, a method of displaying an advertisement can be determined in advance, but the displaying method does not vary for each user. Only a uniform displaying method is provided.

In the conventional advertisement service to an information communication terminal via a telecommunication network, a two-way property, which is a great advantage in connection to a telecommunication network, is lost. When an information communication terminal is connected to a telecommunication network, information can be exchanged bilaterally. However, in the conventional advertisement service to an information communication terminal via a telecommunication network, advertisement information is sent, but little consideration is given to collection of information.

For example, although an advertisement can be effectively supplied in the aforementioned Japanese Patent Laid-Open Publication No. Hei 9-163352, a reaction of a user who viewed the advertisement cannot be obtained at all. In Japanese Patent Laid-Open Publication No. Hei 9-163352, a user is only shown an advertisement, but a user operation induced at the sight of the advertisement or the user's interest cannot be obtained at all.

That is, a cost for sending advertisement data to a user side can be reduced and a method of presenting advertisement data can be controlled with the above-described conventional techniques. However, no consideration is given to utilization of information generated by the user at the sight of the advertisement or feedback of the information. In other words, even though an information terminal is used as an advertising medium, information is provided exactly in the same way as in the case of a conventional unilateral information supply without using a telecommunication network. No consideration is given to making the best of a two-way property, which is an advantage of telecommunication networks, to secure effective customer information by utilizing an information terminal.

### SUMMARY OF THE INVENTION

Accordingly, an object of the present invention is to provide an information communication system and an information terminal device capable of feeding customer use information generated upon presentation of advertisement information back to an advertisement providing source via a telecommunication network and a program recording medium recording an advertisement information presenting and advertisement use information collecting program.

To achieve the above object, according to a first aspect of the invention, there is provided an information communication system including an information terminal device and an information collecting device capable of exchanging information therebetween via communication means, wherein

the information terminal device comprising:

advertisement information saving means for saving advertisement information;

display means;

advertisement presenting means for displaying the saved advertisement information on the display means;

advertisement using means for detecting a user operation by a user interface occurring upon display of an advertisement or any other user operation during the display of the advertisement, instructing a service based on the displayed advertisement and outputting advertisement use information indicating a use situation of the displayed advertisement;

advertisement use information storing means for storing the advertisement use information; and

advertisement use information sending means which is connected to the communication means and sends the stored advertisement use information to the information collecting device via the communication means; and wherein

the information collecting device comprising:

advertisement use information receiving means which is connected to the communication means and receives the advertisement use information sent from the information terminal device via the communication means; and

advertisement use information collecting means for collecting the received advertisement use information;

the information communication system, and wherein

the advertisement information saving means, advertisement presenting means, advertisement using means and advertisement use information storing means in the information terminal device can operate even in a state that the advertisement use information sending means is not connected to the communication means.

According to this constitution, advertisement information is presented on display means by the advertisement presenting means in the information terminal device. When a user operation by a user interface which occurs upon display of an advertisement or any other user operation during the display of the advertisement is detected by advertisement using means, a service based on the displayed advertisement (presentation of detailed information of a displayed advertisement or the like) is instructed. Furthermore, advertisement use information indicating a use situation of the displayed advertisement (the number of user operations in response to the displayed advertisement (service requests) or the like) is stored in advertisement use information storing means. This operation is enabled even in an offline state, in which the terminal is not connected to communication means.

Furthermore, the advertisement use information stored as described above is sent to the information collecting device by advertisement use information sending means via the communication means. Then, the advertisement use information received by advertisement use information receiving means in the information collecting device is collected by advertisement use information collecting means.

The advertisement use information thus collected is information of a customer interested in the presented advertisement and good customer information, the use of which is expected for sales promotion. Services based on the displayed advertisement include presentation of a contact number, access to a home page of the information provider (advertiser) via the communication means and the like in addition to the presentation of detailed information.

One embodiment includes an information supplying device capable of exchanging information with the information terminal device via the communication means; wherein

the information supplying device is connected to the communication means and has advertisement information supplying means for sending advertisement information to the information terminal device via the communication means; and

the information terminal device is connected to the communication means and has advertisement information acquiring means for receiving advertisement information sent from the advertisement information supplying means via the communication means.

According to this constitution, advertisement information saved in advertisement information saving means in the information terminal device is supplied by advertisement information supplying means in an information supplying device via the communication means. Thus, advertisement information saved on the information terminal device side is prevented from becoming out-dated. Relatively old advertisement information having the same contents is prevented from being repeatedly presented to a user.

In one embodiment, the information collecting device and the information supplying device are mounted on the same equipment and directly exchange information with each other.

According to this constitution, the information supplying device can operate in conjunction with the information collecting device. That is, the information supplying device can supply advertisement information to the information terminal device based on advertisement use information collected by the information collecting device.

In one embodiment, the information collecting device and the information supplying device exchange information with each other via the communication means.

According to this constitution, the information supplying device can operate in conjunction with the information collecting device installed at a remote place. That is, the information supplying device can provide advertisement information to the information terminal device based on advertisement use information collected in a large area by the information collecting device.

In one embodiment the advertisement information acquiring means in the information terminal device sends a request for acquisition of advertisement information to the advertisement information supplying means in the information supplying device; and

the information supplying device receives the request for acquisition of advertisement information, analyzes advertisement use information collected by the information collecting device and has advertisement use information analyzing means for determining advertisement information to be sent to the information terminal device based on an analytical result.

According to this constitution, advertisement use information collected by the information collecting device is analyzed by the information supplying device. Based on this analytical result, advertisement information to be sent is determined. Thus, interesting advertisement information reflecting a preference is supplied to a user while information is supplied to a better customer for an advertiser. Thus, both the user and the advertiser have an advantage.

According to a second aspect of the invention, there is provided an information terminal device capable of sending information via communication means comprising:

advertisement information saving means for saving advertisement information;

display means;

advertisement presenting means for displaying the saved advertisement information on the display means;

advertisement using means for detecting a user operation by a user interface occurring upon display of an advertisement or any other user operation during the display of the advertisement, instructing a service based on the displayed advertisement and outputting advertisement use information indicating a use situation of the displayed advertisement;

advertisement use information storing means for storing the advertisement use information; and

advertisement use information sending means which is connected to the communication means and sends the stored advertisement use information to external devices via the communication means; wherein

the advertisement information saving means, advertisement presenting means, advertisement using means and advertisement use information storing means can operate even in a state that the advertisement use information sending means is not connected to the communication means.

According to this constitution, advertisement information is presented on display means by the advertisement presenting means in the information terminal device. When a user operation by a user interface which occurs upon display of an advertisement or any other user operation during the display of the advertisement is detected by advertisement using means, a service based on the displayed advertisement (presentation of detailed information of a displayed advertisement or the like) is instructed. Furthermore, advertisement use information indicating a use situation of the displayed advertisement (the number of user operations in response to the displayed advertisement (service requests) or the like) is stored in the advertisement use information storing means. This operation is enabled even in an offline state, in which the terminal is not connected to the communication means.

Furthermore, the advertisement use information stored as described above is sent to an external device by the advertisement use information sending means via the communication means.

The advertisement use information thus stored or sent is information of a customer interested in the presented advertisement and good customer information, the use of which is expected for sales promotion. Services based on the displayed advertisement include presentation of a contact number, access to a home page of the information provider (advertiser) via the communication means and the like in addition to the presentation of detailed information.

In one embodiment, the advertisement presenting means determines advertisement information to be displayed on the display means based on advertisement use information stored in the advertisement use information storing means.

According to this constitution, advertisement information to be presented is determined by the advertisement presenting means based on advertisement use information stored in the advertisement use information storing means. Thus, interesting advertisement information reflecting a user's preference is presented to a user solely by this information terminal device.

One embodiment further comprises advertisement information acquiring means connected to the communication means for receiving advertisement information sent from an external device via the communication means.

According to this constitution, advertisement information presented to a user can be updated and thereby advertisement information is prevented from becoming outdated.

In one embodiment, the advertisement presenting means displays an advertisement by utilizing part of a screen displayed on the display means for prompting a user for confirmation; and

a service instructed by the advertisement using means is changing contents of the display advertisement.

According to this constitution, when the user operation is performed while an advertisement is displayed by utilizing part of a screen for prompting a user for confirmation, contents of the displayed advertisement are changed, for example, to detailed information or the like. Thus, when the user shows an interest in the displayed advertisement, detailed information of the advertisement is displayed.

According to one embodiment, the advertisement presenting means displays the advertisement when power is turned off; and

the advertisement using means suspends the turning off of the power to instruct the service.

According to this constitution, when power is turned off, that is, at a timing when use of the information terminal device is finished, an advertisement is presented. When the user operation is detected by the advertisement using means, the operation of turning off power is temporarily suspended and the service is provided.

Thus, when an advertisement is presented at a timing when use of this information terminal device is finished, the presented advertisement attracts an interest from a user and the above user operation occurs, both the information terminal device and the user have only to perform an operation derived from the user operation. Thus, various services can be performed.

According to one embodiment, the advertisement presenting means displays an advertisement by utilizing part of a warning screen displayed on the display means when an application program is waiting for an operation; and

a service instructed by the advertisement using means is changing contents of the operation started immediately after the operation wait state finishes.

According to this constitution, for example, to utilize the WWW (World Wide Web), an advertisement is presented on part of a warning screen during a wait time for connection to the Internet as the communication means. Immediately after the user operation is detected, the terminal is connected to the communication means and a wait state is finished, a page first displayed is changed to a home page of an advertiser. Thus, a user is spontaneously guided from presentation of an advertisement to a sales service.

One embodiment comprises condition specifying means for specifying an execution start condition of the service instructed by the advertisement using means;

execution start condition registering means for registering the execution start condition specified by the condition specifying means when the user operation is detected by the advertisement using means; and

service executing means for monitoring satisfaction of the execution start condition registered in the execution start condition registering means and starting execution of the service when the condition is satisfied.

According to this constitution, execution of a service (application) desired by a user is reserved by registering an execution start condition of the service in the execution start condition registering means. Execution of the service is started by the service executing means when the execution start condition is satisfied.

Therefore, for example, when the service (application) is acquisition of home page information of an advertiser, the acquisition start time is registering and reserved so that this acquisition is performed in a batch later. The Internet is automatically connected and the acquisition is performed in a batch while a user is asleep. Thus, the acquired home page information of the advertiser can be browsed after a certain period of time solely by this information terminal device without being connected to the network.

According to a third aspect of the invention, there is provided a program recording medium readable by a computer, wherein

an advertisement information presenting and advertisement use information collecting program for allowing a computer to function as the advertisement information saving means, advertisement presenting means, advertisement using means, advertisement use information storing means and advertisement use information sending means is recorded.

According to this constitution, advertisement information is presented to a user. When a user operation by a user interface which occurs upon display of an advertisement or any other user operation during the display of the advertisement is detected, a service based on the displayed advertisement is instructed. Furthermore, advertisement use information indicating a use situation of the displayed advertisement is stored in advertisement use information storing means. Then, the stored advertisement use information is sent to an external device via the communication means.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram showing a functional constitution of an information communication system according to the present invention;

FIGS. 2A and 2B are explanatory views of a method of presenting and using an advertisement by the advertisement presenting unit and the advertisement using unit in FIG. 1;

FIG. 3 is a schematic flow chart of an advertisement information presenting/updating and advertisement use information collecting operation;

FIG. 4 is a flow chart of an advertisement use information collecting operation by the information terminal device in FIG. 1;

FIG. 5 is a flow chart of an advertisement use information collecting operation by the information collecting device in FIG. 1;

FIG. 6 is a flow chart of an advertisement information selecting and sending operation by the information terminal device;

FIG. 7 is a flow chart of advertisement information selecting and sending operation by the information supplying device in FIG. 1;

FIG. 8 shows changes in data in each of the saving unit, storing unit and collecting unit during the advertisement information presenting/updating and advertisement use information collecting operation;

FIG. 9 shows changes in data following FIG. 8;

FIGS. 10A and 10B are explanatory views of a method of presenting and using an advertisement different from the method in FIGS. 2A and 2B;

FIGS. 11A, 11B and 11C are explanatory views of a method of presenting and using an advertisement different from the methods in FIGS. 2A, 2B, 10A and 10B;

FIG. 12 is a block diagram showing a hardware constitution of the information terminal device;

FIG. 13 is a block diagram showing a functional constitution of the information terminal device according to the present information;

FIGS. 14A and 14B show data constitution in the advertisement information saving unit and the advertisement use information storing unit in FIG. 13; and

FIGS. 15A, 15B, 15C, 15D, 15E and 15F show changes in contents in the advertisement use information storing unit in FIG. 13, contents of displayed advertisement and presence/absence of advertisement use.

### DETAILED DESCRIPTION OF THE PREFERRED EMBODIMENTS

The present invention is described in detail below with reference to embodiments shown in drawings. In each embodiment below, the Internet is assumed as a telecommunication network environment. The WWW (World Wide Web) environment and its browser are assumed as communication means and its display application. HTML (Hyper Text Markup Language) is assumed as a structured document. However, a requirement for the present invention is presence of a telecommunication network and information collecting means under the environment. It is apparent that the present invention can be applied even if the aforementioned telecommunication network environment, communication means or data structure is replaced with other constitutions.

### First Embodiment

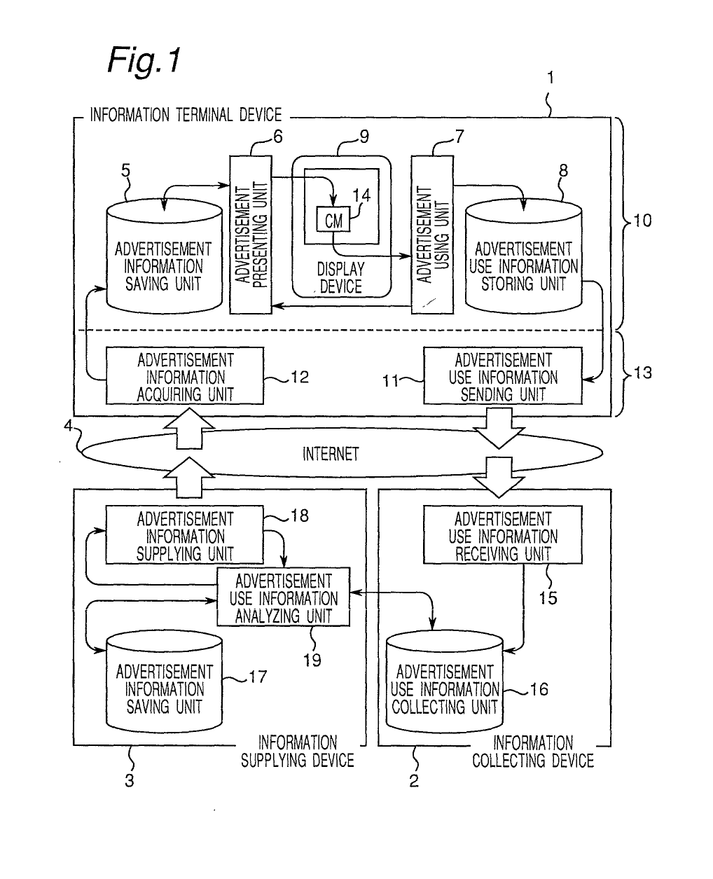

FIG. 1 is a block diagram showing an example of a functional constitution of an information communication system according to this embodiment. This information communication system is generally constituted by an information terminal device 1, information collecting device 2 and information supplying device 3. Information can be transmitted between the information terminal device 1 and the information collecting device 2 or the information supplying device 3 via the Internet 4 as the telecommunication network environment. The information terminal device 1 can operate even in a state that the device is not connected to the Internet 4.

The information terminal device 1 is constituted by an offline operation unit 10 having an advertisement information saving unit 5, advertisement presenting unit 6, advertisement using unit 7, advertisement use information storing unit 8 and display device 9 and an online operation unit 13 having an advertisement use information sending unit 11 and advertisement information acquiring unit 12.

The advertisement information saving unit 5 is a section in which advertisement information to be presented to a user is saved and corresponds to the advertisement information saving means. Here, contents of advertisement information are not particularly defined, but an example is shown later. A method of storing advertisement information in the advertisement information saving unit 5 is provided by a method of setting the information in the advertisement information saving unit 5 at the time of shipment in advance, a method of downloading the information from a personal computer, a method of receiving a supply of the information from the information supplying device 3 or the like or by their appropriate combination.

The advertisement presenting unit 6 is a section for displaying the advertisement information saved in the advertisement information saving unit 5 on the display device 9 and corresponds to the advertisement information presenting means. This unit obtains a timing of presenting an advertisement, a size of an area for displaying the advertisement, a given time period and the like from the advertisement information read from the advertisement information saving unit 5 and performs a display processing to the display device 9 depending on these obtained conditions. An advertisement is displayed in an area 14 in the display device 9 in FIG. 1.

The advertisement using unit 7 is a section for achieving a user interaction with an advertisement displayed in the display device 9 and detecting a user operation in response to the advertisement and corresponds to the advertisement using means. Specific contents are described later. Here, a user operation detected by the advertisement using unit 7 is possible only by displaying an advertisement. Therefore, when the user performs this operation, it is judged that the user is interested in the presented advertisement. When a few kinds of operations are made possible, the intensity of the user's interest can be measured by checking which operation is performed.

The advertisement use information storing unit 8 is a section for storing a degree of a user's interest in an advertisement detected by the advertisement using unit 7 and corresponds to the advertisement use information storing means.

The offline operation unit 10 in the information terminal device 1 having this constitution is a section capable of operating in a state that the device is not connected to the Internet 4 (offline state). In this embodiment, display of advertisement information and collection of information on the degree of the user's interest in an advertisement are performed only by the offline operation unit 10.

The advertisement use information sending unit 11 is a section for sending the advertisement use information accumulated in the advertisement use information storing unit 8 to the information collecting device 2 and corresponds to the advertisement use information sending means. Here, the advertisement use information to be sent is on the degree of a user's interest in an advertisement and utilized as customer information. Specifically, the information includes a time when the advertisement is referred to, its duration, the number of times of references, a referencing method, a degree of utilization of related information from the displayed advertisement and the like. If possible, this information can have a higher value by including a user profile and the like in this use information.

Here, an operation of the advertisement use information sending unit 11 may be activated directly by an instruction from a user or the operation may be automatically performed at certain intervals. Or, the operation may be performed between other processings performed in connection with the Internet 4 (for example, mail delivery confirmation or the like).

The advertisement information acquiring unit 12 is a section for acquiring the advertisement information sent from the information supplying device 3 and saving the information in the advertisement information saving unit 5 and corresponds to the advertisement information acquiring means.

The online operation unit 13 in the information terminal device 1 having the above constitution is a section for operating in a state that the device is connected to the Internet 4 (online state). This unit sends advertisement use information to the information collecting device 2 and acquires advertisement information from the information supplying device 3.

The information collecting device 2 is constituted by an advertisement use information receiving unit 15 and an advertisement use information collecting unit 16.

The advertisement use information receiving unit 15 is a section for receiving advertisement use information sent from the information terminal device 1 via the Internet 4 and corresponds to the advertisement use information receiving means. This advertisement use information receiving unit 15 exchanges connection information and is connected to the advertisement use information sending unit 11 on the information terminal device 1 side and then the unit receives the advertisement use information therefrom.

The advertisement use information collecting unit 16 is a section for collecting the advertisement use information from the information terminal device 1 received by the advertisement use information receiving unit 15 and corresponds to the advertisement use information collecting means. Here, the advertisement use information collected by the advertisement use information collecting unit 16 is information on a good customer and becomes fundamental data for retention marketing.

As described above, one information communication system is constituted by a section of the advertisement information saving unit 5, advertisement presenting unit 6, advertisement using unit 7, advertisement use information storing unit 8, display device 9 and advertisement use information sending unit 11 in the information terminal device 1, a section of the advertisement use information receiving unit 15 and advertisement use information collecting unit 16 in the information collecting device 2 and the Internet 4 connecting these sections. By using this information communication system, firstly, advertisement can be performed by presenting advertisement information while a user is using the information terminal device 1 irrespective of whether the device is connected to the Internet 4. Secondly, a degree of interest is detected based on a user operation in response to the presented advertisement and advertisement use information for understanding an effect of the advertisement and user needs can be accumulated. Thirdly, the accumulated advertisement use information can be provided to the information collecting device 2 in a stable manner. This collection of the advertisement use information is important for marketing. This suggests usefulness of the present invention.

The information supplying device 3 is constituted by an advertisement information saving unit 17, advertisement information supplying unit 18 and advertisement use information analyzing unit 19.

The advertisement information saving unit 17 is a section for saving advertisement information prepared on an advertiser side and corresponds to the advertisement information saving means. The advertisement information supplying unit 18 is a section for sending the advertisement information prepared in the advertisement information saving unit 17 to the information terminal device 1 and corresponds to the advertisement information supplying means.

As described above, the above-described method of storing advertisement information in the advertisement information saving unit 5 is realized by a section of the advertisement information saving unit 17 and the advertisement information supplying unit 18 in the information supplying device 3, a section of the advertisement information acquiring unit 12 in the information terminal device 1 and the Internet 4 connecting these sections. Thus, advertisement information can be updated via the Internet 4.

The advertisement use information analyzing unit 19 is a section for analyzing advertisement use information collected by the information collecting device 2 to determine advertisement information to be provided to the information terminal device 1 and corresponds to the advertisement use information analyzing means. This advertisement use information analyzing unit 19 can be considered to be one of means for using the advertisement use information, that is, customer information.

According to the information communication system constituted by the information terminal device 1 and the information supplying device 3, advertisement information meeting needs can be accumulated in the information terminal device 1 by selecting advertisement information based on the advertisement use information reflecting user needs. Consequently, it can be expected that the advertisement information is further used by the user. Then, more pieces of highly accurate advertisement use information can be collected.

Therefore, information is refined since a series of cycles are formed by the above-described information communication system constituted by the information terminal device 1 and the information collecting device 2 and the information communication system constituted by the information terminal device 1 and the information supplying device 3. Thus, information further meeting user needs can be provided. That is, realization of the aforementioned cycles leads to creation of good customers and maintenance of customers.

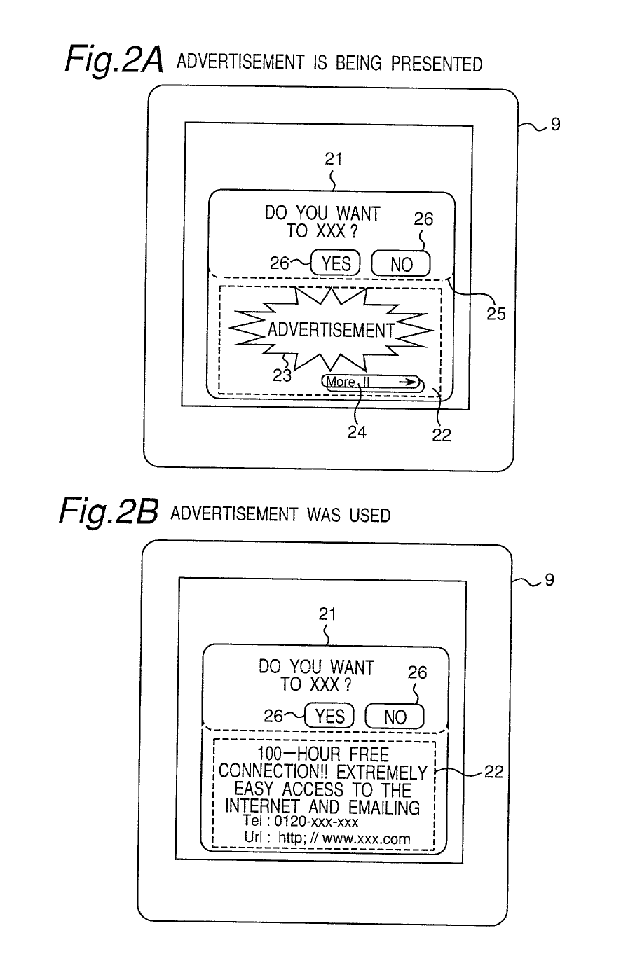

A display example of advertisement information on the display device 9 and a user operation based on the displayed screen are described below. FIGS. 2A and 2B show display examples on the display device 9. FIG. 2A shows that an advertisement is being presented. FIG. 2B shows that an advertisement was used. In these display examples, an advertisement is presented by utilizing part of a screen for prompting a user for confirmation.

In FIG. 2A, reference numeral 21 denotes an alert box, which is a display area for requiring confirmation about whether an operation is possible. 22 denotes an advertisement display area occupying a lower half of the alert box 21. 23 denotes an illustration of an advertisement. The design must stand out to attract an interest from a user. 24 denotes a display transition button for causing a transition of display contents to further detailed information of the currently displayed advertisement contents. When this display transition button 24 is pressed, the display contents of the advertisement display area 22 are changed to FIG. 2B. 25 denotes a lower edge of the alert when no advertisement is displayed. 26 denotes a confirmation button for inputting user confirmation, which is an original function of the alert.

FIG. 2B shows that an advertisement was used. Further detailed advertisement contents of the advertisement contents displayed in FIG. 2A is displayed. In this case, since the confirmation button 26 is not pressed in FIG. 2A, contents of the alert box 21 do not change. The display contents of the advertisement display area 22 are changed to further detailed information of the advertisement in FIG. 2A. Thus, an advertisement is displayed without deteriorating the part of the original function of the alert box 21.

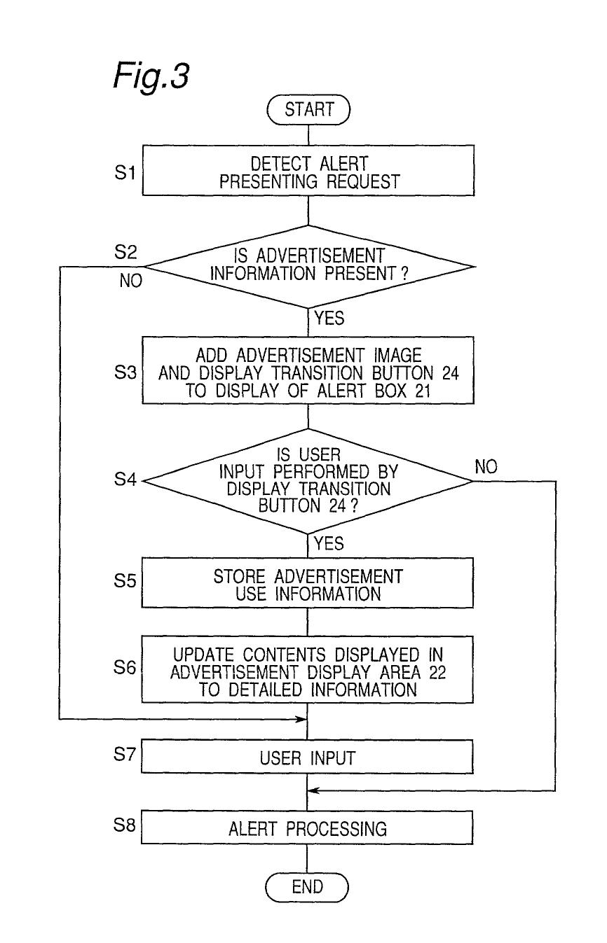

FIG. 3 is a schematic flow chart of an advertisement information presenting/updating and advertisement use information collecting operation along with the displays shown in FIGS. 2A and 2B. This advertisement information presenting/updating and advertisement use information collecting operation is constituted by the following three phases.

(1) Advertisement information is presented and advertisement use information is detected by the information terminal device 1.

(2) The information terminal device 1 in conjunction with the information collecting device 2 collects advertisement use information.

(3) The information supplying device 3 playing a central role selects the next advertisement information based on the collected advertisement use information in conjunction with the information terminal device 1 and the information collecting device 2 and sends the information to the information terminal device 1.

The advertisement information presenting/updating and advertisement use information collecting operation is described in detail below. First, an advertisement information presenting and advertisement use information detecting operation executed by the information terminal device 1 is described with reference to the flow chart in FIG. 3.

In step S1, a request for presentation of an alert from an application program or the like is detected by the advertisement presenting unit 6 in the information terminal device 1. In step S2, whether advertisement information is saved in the advertisement information saving unit 5 is judged by the advertisement presenting unit 6. As a result, when the information is saved, the processing proceeds to step S3. The processing proceeds to step S7 when the information is not saved. In step S3, the alert box 21 displayed on the display device 9 is extended and an advertisement display area 22 is secured by the advertisement presenting unit 6. Then, an advertisement image based on the advertisement information read from the advertisement information saving unit 5 and the display transition button 24 are additionally displayed in the advertisement display area 22. Here, the display transition button 24 is a button for displaying detailed information of an advertisement and also for using the displayed advertisement.

In step S4, whether an input by a user is performed by pressing the display transition button 24 is judged. As a result, when the display transition button 24 is pressed, the advertisement using unit 7 is activated and the processing proceeds to step S5. When the display transition button 24 is not pressed (that is, the confirmation button 26 is pressed), the processing proceeds to step S8. In step S5, pressing of the display transition button 24 is detected and use of the advertisement whose image is displayed in step S3 is detected by the advertisement using unit 7. Then, advertisement use information indicating that the advertisement was used is sent and stored in the advertisement use information storing unit 8. In step S6, updating of the contents displayed in the advertisement display area 22 is requested to the advertisement presenting unit 6 by the advertisement using unit 7. Then, detailed information of the advertisement displayed in step S3 is read from the advertisement information saving unit 5 by the advertisement presenting unit 6 and the contents displayed in the advertisement display area 22 are updated. As a result, the contents displayed in the display device 9 are changed to FIG. 2B.

Thus, information on operations of the display transition button 24 by the user is accumulated as the advertisement use information in the advertisement use information storing unit 8 while detailed information of the displayed advertisement is presented to the user.

In step S7, pressing of the confirmation button 26 by the user is detected. In step S8, an operation displayed in the alert box 21 based on the alert presenting request is processed in response to the confirmation button 26 pressed in step S4 or step S7. Specifically, the selected content (“Yes” or “No”) is notified to the application program requesting presentation of the alert in step S1 or the like. Then, the advertisement information presenting and advertisement use information detecting operation is finished.

Thus, the advertisement display area 22 is provided in part of the alert box 21 so that the advertisement image and the display transition button 24 are displayed. When the user shows an interest in the displayed advertisement and presses the display transition button 24, the contents displayed in the advertisement display area 22 are updated to detailed information. At the same time, advertisement use information is generated and accumulated in the advertisement use information storing unit 8. In this case, the alert displayed in the alert box 21 is not lost. On the other hand, when the user is not interested in the displayed advertisement and presses the confirmation button 26, a normal alert processing is performed.

Therefore, according to this embodiment, the advertisement use information of the user can be accumulated while advertisement information is presented to the user.

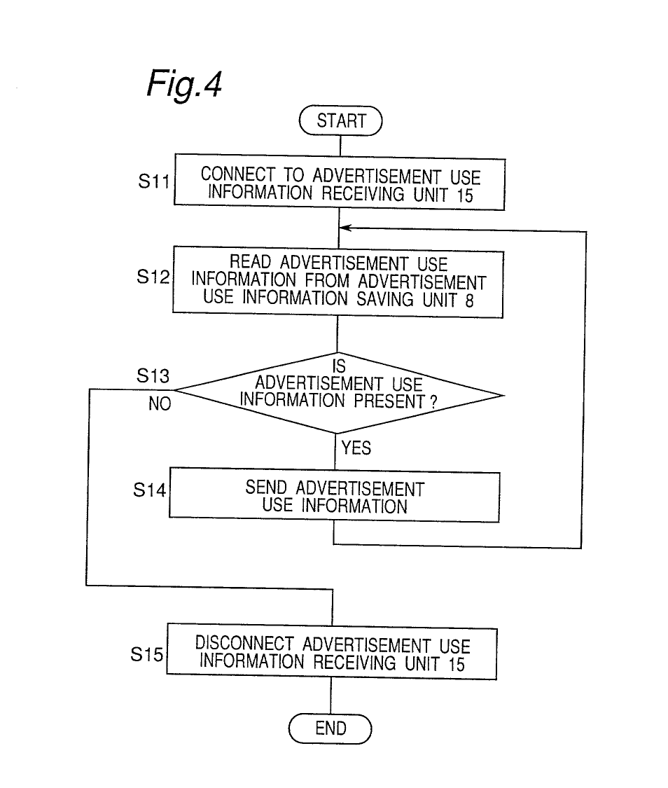

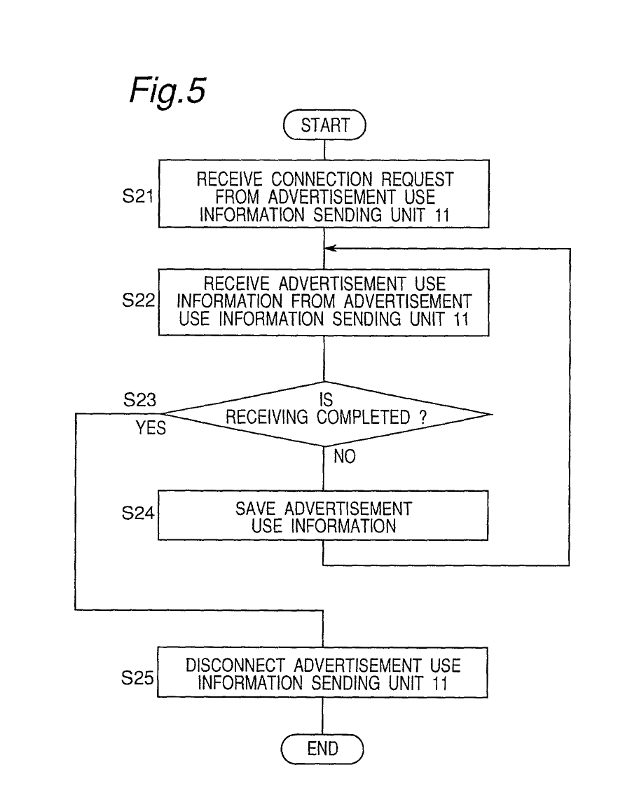

An advertisement use information collecting operation executed by the information terminal device 1 and the information collecting device 2 is described below with reference to flow charts in FIGS. 4 and 5. FIG. 4 is a flow chart of processings by the information terminal device 1. FIG. 5 is a flow chart of processing by the information collecting device 2. First, processings by the information terminal device 1 are described with reference to FIG. 4.

In step S11, the advertisement use information receiving unit 15 in the information collecting device 2 is connected to the advertisement use information sending unit 11. In step S12, the advertisement use information is read from the advertisement use information storing unit 8 by the advertisement use information sending unit 11. In step S13, whether advertisement use information is present is judged. As a result, when the information is present, the processing proceeds to step S14. If not, the processing proceeds to step S15. In step S14, the read advertisement use information is sent to the information collecting device 2 by the advertisement use information sending unit 11. Then, the processing goes back to step S12 and the next advertisement use information is read. In step S15, the advertisement use information receiving unit 15 is disconnected and the advertisement use information collecting operation is finished.

Processings by the information collecting device 2 are described below with reference to FIG. 5. In step S21, a request for connection is received from the advertisement use information sending unit 11 in the information terminal device 1. In step S22, the advertisement use information sent from the advertisement use information sending unit 11 is received by the advertisement use information receiving unit 15. In step S23, whether the receiving is completed is judged based on receiving information. As a result, when receiving is completed, the processing proceeds to step S25. If not, the processing proceeds to step S24. In step S24, the received advertisement use information is saved by the advertisement use information collecting unit 16. Then, the processing goes back to step S22 and the next advertisement use information is received. In step S25, the advertisement use information sending unit 11 in the information terminal device 1 is disconnected and the advertisement use information collecting operation is finished.

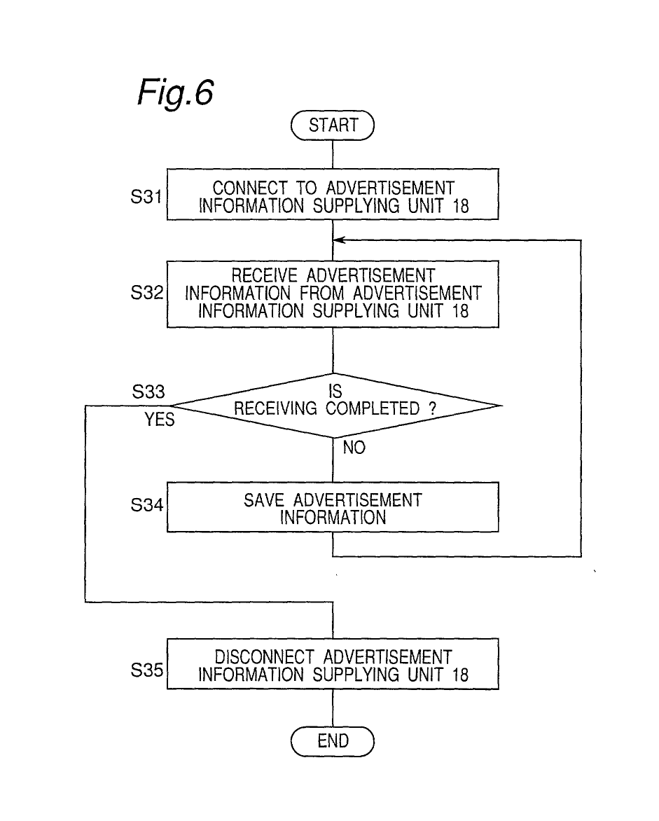

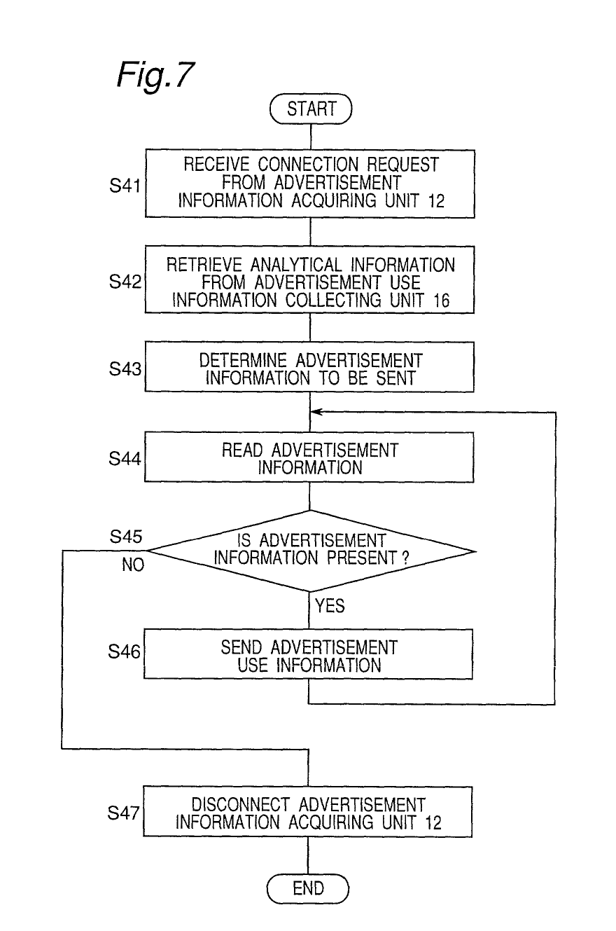

Finally, an advertisement information selecting/sending operation executed by the information supplying device 3, information terminal device 1 and information collecting device 2 is described below with reference to flow charts in FIGS. 6 and 7. FIG. 6 is a flow chart of processings by the information terminal device 1. FIG. 7 is a flow chart of processings by the information supplying device 3. Here, the information collecting device 2 and the information supplying device 3 share advertisement use information held by the advertisement use information collecting unit 16. The advertisement use information analyzing unit 19 in the information supplying device 3 directly accesses the advertisement use information collecting unit 16. First, processings by the information terminal device 1 are described with reference to FIG. 6.

In step S31, the advertisement information supplying unit 18 in the information supplying device 3 is connected to the advertisement information acquiring unit 12. In step S32, advertisement information sent from the advertisement information supplying unit 18 is received by the advertisement information acquiring unit 12. In step S33, whether receiving is completed is judged based on the receiving information. As a result, when receiving is completed, the processing proceeds to step S35. On the other hand, if not, the processing proceeds to step S34. In step S34, the received advertisement information is saved by the advertisement information saving unit 5. Then, the processing goes back to step S32 and the next advertisement information is received. In step S35, the advertisement information supplying unit 18 in the information supplying device 3 is disconnected and the advertisement information selecting/sending operation is finished.

Processings by the information supplying device 3 are described below with reference to FIG. 7. In step S41, a request for connection is received from the advertisement information acquiring unit 12 in the information terminal device 1. In step S42, in response to a request for a supply of advertisement information from the advertisement information supplying unit 18, the advertisement use information saved in the advertisement use information collecting unit 16 is retrieved by the advertisement use information analyzing unit 19. In step S43, advertisement information suitable for the information terminal device 1 requesting a supply of the advertisement information is determined by the advertisement use information analyzing unit 19 based on the retrieved advertisement use information. In step S44, the determined advertisement information is read from the advertisement information saving unit 17 by the advertisement use information analyzing unit 19. In this embodiment, as described above, reading of advertisement information is requested from the advertisement information supplying unit 18 to the advertisement use information analyzing unit 19.

In step S45, whether the advertisement information is present is judged. As a result, when the information is present, the processing proceeds to step S46. If not, the processing proceeds to step S47. In step S46, the read advertisement information is sent to the advertisement information acquiring unit 12 by the advertisement information supplying unit 18. Then, the processing goes back to step S44 and the next advertisement information is read. In step S47, the advertisement information acquiring unit 12 is disconnected and the advertisement information selecting/sending operation is finished.

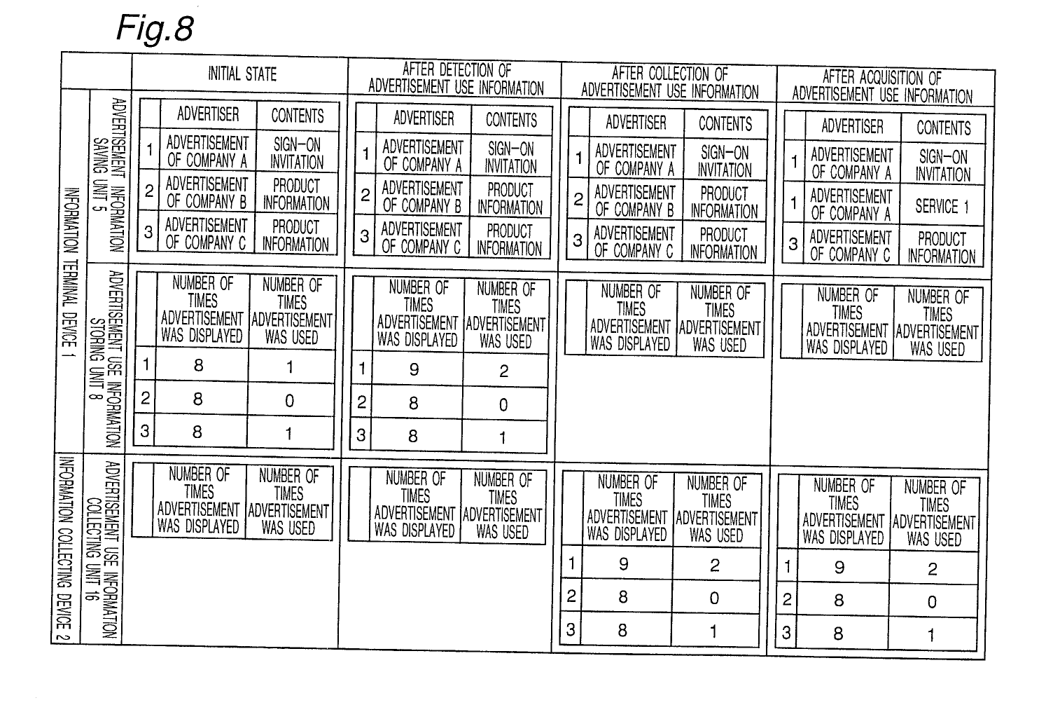

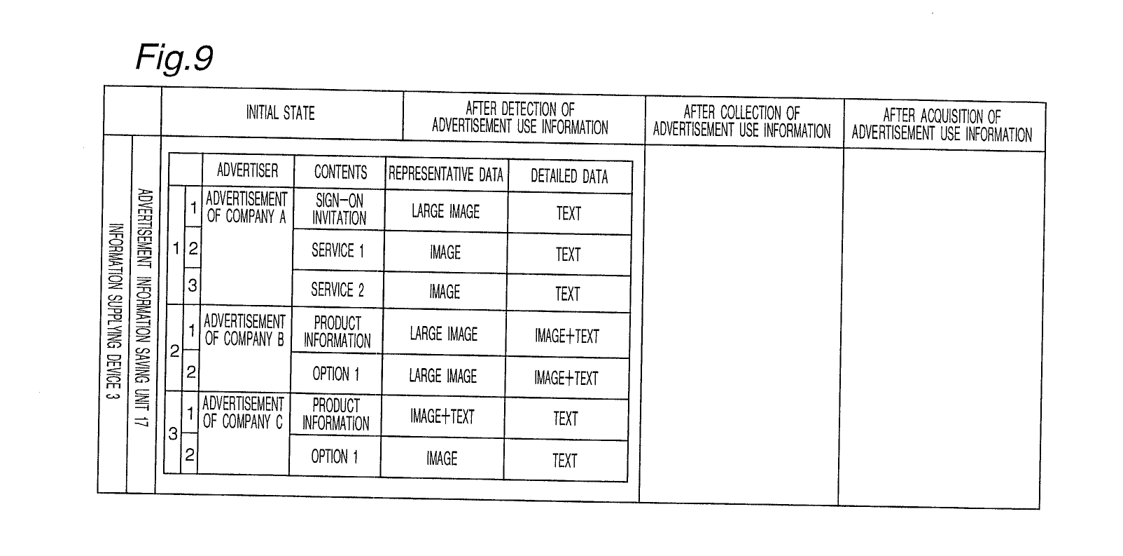

FIGS. 8 and 9 show an example of transition of data in the advertisement information saving unit 5, advertisement use information storing unit 8, advertisement use information collecting unit 16 and advertisement information saving unit 17 during the advertisement information presenting/updating and advertisement use information collecting operation. The data are classified into those in an initial state, those after detection of the advertisement use information, those after collection of the advertisement use information and those after acquisition of the advertisement information. Here, advertisement information of three companies, A, B and C is handled. It is assumed that one information terminal device 1 is used.

First, the data constitution in the initial state is as follows.

(A) Advertisement information saving unit 5 in information terminal device 1

Part of advertisement data saved in the advertisement information saving unit 17 in the information supplying device 3 described later is copied. That is, in the initial state, “representative data” and “detailed data” out of advertisement data in the advertisement information saving unit 17 are omitted.

(B) Advertisement use information storing unit 8 in information terminal device 1

In this example, the numbers of times the advertisement data of the three companies saved in the advertisement information saving unit 17 are displayed and used are stored. In the initial state, the advertisements of all the three companies are displayed 8 times each. The advertisements of companies A and B are used once each.

(C) Advertisement use information collecting unit 16 in information collecting device 2

In this example, there is no data yet.

(D) Advertisement information saving unit 17 in information supplying device 3

Advertisement information of advertisers, companies A, B and C, is saved. In this example, three kinds of advertisements are prepared for company A. Two kinds of advertisements are prepared for respective companies B and C. Advertisement information is not increased or decreased for convenience in this example. Therefore, contents saved in the advertisement information saving unit 17 are not mentioned in the following description.

The data constitution after detection of the advertisement use information is as follows. “After detection of the advertisement use information” means after use of an advertisement is detected by the advertisement using unit 7. Here, an advertisement of company A saved in the advertisement information saving unit 5 in the information terminal device 1 is presented and a user confirms presentation of its detailed information.

(E) Advertisement information saving unit 5 in information terminal device 1

At the time when the advertisement is used, its effect is not reflected on contents in the advertisement information saving unit 5 in the information terminal device 1 and the contents remain the same as in the initial state.

(F) Advertisement use information storing unit 8 in information terminal device 1

Since the advertisement of company A is presented and the user confirms presentation of its detailed information, the number of times the advertisement of company A was displayed is increased by “1” to 9 times. The number of times of its use is also increased by “1” to twice.

(G) Advertisement use information collecting unit 16 in information collecting device 2

Since, at the time when the advertisement is used, its effect is not reflected on contents of the advertisement use information collecting unit 16 in the information collecting device 2, the contents remain the same as in the initial state.

The data constitution after collection of the advertisement use information is as follows. “After collection of the advertisement use information” means immediately after the advertisement use information is saved in the advertisement use information collecting unit 16.

(H) Advertisement information saving unit 5 in information terminal device 1

Since, at the time when the advertisement use information is collected, its effect is not reflected on contents of the advertisement information saving unit 5 in the information terminal device 1, the contents remain the same as in the initial state.

(I) Advertisement use information storing unit 8 in information terminal device 1

Since the advertisement use information detected and stored in the advertisement use information storing unit 8 is sent to the information collecting device 2 side, the contents stored in the advertisement use information storing unit 8 are cleared.

(J) Advertisement use information collecting unit 16 in information collecting device 2

The advertisement use information sent from the information terminal device 1 side (the same contents as those of the advertisement use information storing unit 8 before sent) is saved. In this example, since data is not saved in the initial state, the contents stored in the advertisement use information storing unit 8 before sent are copied as they are. If data is saved in the initial state, received data is added to the saved data.

The data constitution after acquisition of the advertisement information is as follows. “After acquisition of the advertisement information” means immediately after the advertisement information is saved in the advertisement information saving unit 5. Here, the advertisement use information analyzing unit 19 in the information supplying device 3 determines the number of pieces of advertisement information to be sent to the information terminal device 1 in proportion to the number of times the advertisement was used. The advertisement use information on company A is “2”, the advertisement use information on company B is “0” and the advertisement use information on company C is “1”. Therefore, “2” and “1” are sent as the advertisement information on the company A advertisement and the advertisement information on the company C advertisement, respectively, from the advertisement information supplying unit 18 in the information supplying device 3 to the advertisement information acquiring unit 12 in the information terminal device 1.

(K) Advertisement information saving unit 5 in information terminal device 1

As described above, two pieces of company A advertisement information (“sign-up invitation”, “service 1”), no company B advertisement information and one piece of company C advertisement information (“product information”) are transmitted between the information supplying device 3 and the information terminal device 1. Therefore, the company A advertisement information, “sign-up invitation”, “service 1”, and the company C advertisement information, “product information”, are saved in the advertisement information saving unit 5 in the information terminal device 1. Thus, the advertisement of company B, for which no user needs is detected, is eliminated and thereby the two pieces of company A advertisement closer to the user needs are saved.

(I) Advertisement use information storing unit 8 in information terminal device 1

Since its effect is not reflected on contents in the advertisement use information storing unit 8 in the information terminal device 1 at the time when the advertisement information in the advertisement information saving unit 5 in the information terminal device 1 is updated, the contents remains cleared.

(J) Advertisement use information collecting unit 16 in information collecting device 2

At the time when the advertisement information is updated, its effect is not reflected on contents in the advertisement use information collecting unit 16 in the information collecting device 2.

As described above, in this embodiment, the advertisement information acquiring unit 12, advertisement presenting unit 6, advertisement using unit 7 and advertisement use information sending unit 11 are provided in the information terminal device 1. The advertisement use information receiving unit 15 is provided in the information collecting device 2. The advertisement use information analyzing unit 19 and the advertisement information supplying unit 18 are provided in the information supplying device 3.

In the information terminal device 1, the advertisement display area 22 is set in part of the alert box 21 displayed on the display device 9 to prompt a user to confirm an operation by the advertisement presenting unit 6. An advertisement image and the display transition button 24 for transition to detailed information are displayed in this advertisement display area 22. When the display transition button 24 is operated by the user, advertisement use information is detected and stored in the advertisement use information storing unit 8 by the advertisement using unit 7. Thus, the accumulated advertisement use information is sent to the advertisement use information receiving unit 15 in the information collecting device 2 by the advertisement use information sending unit 11 via the Internet 4.

As a result, information of advertisements with high user needs for each information terminal device 1 is collected in the advertisement use information collecting unit 16 in the information collecting device 2. On the other hand, when there is a request for a supply of advertisement information from the information terminal device 1 side via the Internet 4, the information supplying device 3 analyzes the advertisement use information collected in the advertisement use information collecting unit 16 by the advertisement use information analyzing unit 19. The advertisement information determined based on the analytical result is read from the advertisement information saving unit 17 and sent to the information terminal device 1 by the advertisement information supplying unit 18.

On the information terminal device 1 side, the advertisement information saving unit 5 is updated by using the advertisement information provided as described above. Therefore, the advertisement information in which the user show an interest can be saved in the advertisement information saving unit 5 by utilizing a two-way property of the Internet 4. Thus, advertising activity meeting user needs is performed by effectively using the customer information and thereby customers can be maintained.

In this case, the information terminal device 1 can present the advertisement information and detect the advertisement use information in an offline state. Transmission of information with the information collecting device 2 or the information supplying device 3 can be performed between other processings performed in connection with the Internet 4. Therefore, portability of the information terminal device 1 is not impaired at all.

Furthermore, the advertisement information is presented to the advertisement display area 22 set in part of the alert box 21. Therefore, when the user does not show any interest in an advertisement, the alert box can perform a normal alert function without any operation. Thus, an advertisement can be presented and advertisement use information can be detected without impairing the original functions of the alert box 21.

In this embodiment, contents of an operation to be confirmed by the alert box 21 is not related to contents of a displayed advertisement. A user interface (confirmation button 26) for responding the confirmation and a user interface (display transition button 24) for transition of a display to detailed information of the presented advertisement are separately set. However, this invention is not limited to this setting, but contents of the displayed advertisement can be related to contents of the operation to be confirmed and the user interface for responding the confirmation can also be used as the user interface for transition of a display. In this case, a display user interface is not generated by display of the advertisement. A user operation is performed as “user operation at the time of advertisement display” by the user interface for responding the confirmation. The “user operation at the time of advertisement display” is not limited to an operation by the user interface (user interface other than the user interface generated by the advertisement display), but a concept including key operations or the like.

The advertisement use information analyzing unit 19 in the information supplying device 3 directly accesses the advertisement use information collecting unit 16 in the information collecting device 2. In this case, the information collecting device 2 and the information supplying device 3 are preferably mounted on the same equipment on the advertisement supplying side, but the constitution is not limited to this.

The information collecting device 2 and the information supplying device 3 may be installed in regions far from each other and exchange information via communication means such as the Internet 4 or the like.

### Second Embodiment

The second embodiment relates to a method of presenting/using an advertisement different from a presenting/using method by utilizing an alert box 21 for prompting a user to confirm an operation in the first embodiment.

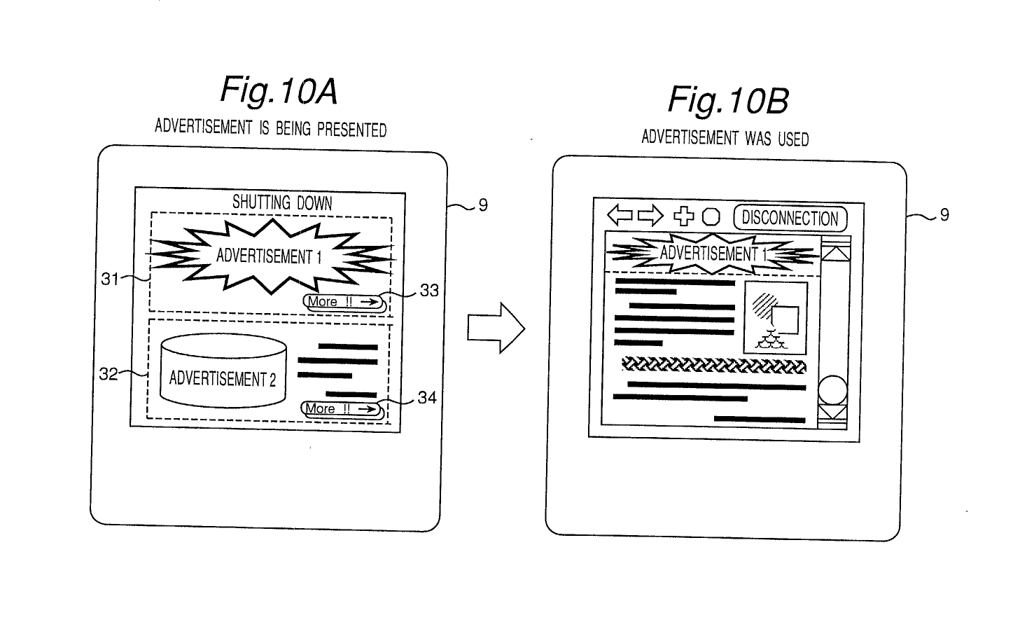

FIGS. 10A and 10B are display examples where a method of presenting and using advertisements on a screen of a display device 9 when power of an information terminal device 1 is turned off is employed as a method of presenting and using advertisement information. FIG. 10A shows that an advertisement is being presented. FIG. 10B shows that an advertisement was used. The advertisement presenting/using method may be used in conjunction with the advertisement presenting/using method in the first embodiment.

As shown in FIG. 10, since power is turned off, only a message of “shutting down” is left on the screen and two advertisements 31, 32 are displayed on the whole screen. Buttons for using the advertisement (display transition buttons) 33, 34 are additionally displayed in respective advertisements 31, 32. In this example, the display transition button 33 in the advertisement 31 displayed on the upper side is pressed and the device is connected to the Internet 4. As shown in FIG. 10B, the home page of the advertiser is displayed. In this case, this can be realized by including the URL (Uniform Resource Location) of a home page to be displayed in detailed information of the advertisement 31 presented in FIG. 10A.

The advertisement presenting method of this embodiment is different from an advertisement presenting method using part of the display (alert box 21) for prompting a user for confirmation such as a method in the first embodiment shown in FIG. 2 in that the screen can be freely utilized and that there is no limit to advertisement use since transition to detailed information includes connection to the Internet 4.

### Third Embodiment

The third embodiment relates to an advertisement presenting/using method different from the advertisement presenting/using methods in the first and the second embodiments.

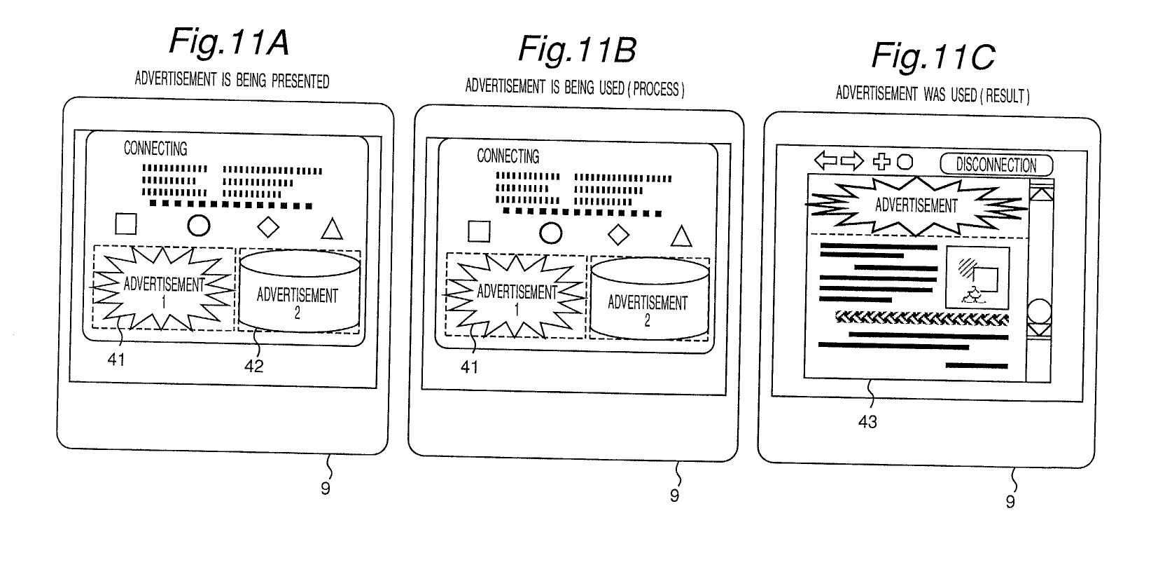

FIGS. 11A, 11B and 11C are display examples where an advertisement presenting method is employed by utilizing part of a warning display displayed on a display device 9 to notify an in-operation state when a wait time occurs during operation of an application program in an information terminal device 1 as a method of presenting and using advertisement information. Here, FIG. 11A shows that an advertisement is being presented. FIG. 11B shows that an advertisement is being used (process). FIG. 11C shows that an advertisement was used (result). In this case as well, it is apparent that this method can be used in conjunction with the advertisement presenting/using method in the first embodiment.

In FIG. 11A, two advertisements 41, 42 are displayed in part of a warning display of “connecting” during a processing of connection to the Internet 4. An advertisement is used by touching the advertisement itself. In this case, when an area of the advertisement 41 is touched by a finger or the like in FIG. 11B, information displayed in a page first displayed by a browser set by the user (hereinafter, referred to home page) is replaced with an advertiser's home page 43 (detailed information of the advertisement 41) upon connection with the Internet 4 as shown in FIG. 11C. At this time, until information displayed on the first home page required by the user is replaced with the advertiser's home page, the part of the advertisement 41 is highlighted in FIG. 11B to show that the user used the advertisement and that a home page to be first displayed is related to the advertisement.

Thus, this embodiment has the following features as compared with the presenting/using methods in the above other embodiments. That is, when an advertisement is presented and used by utilizing part of an alert box 21 for prompting the user for confirmation as in the case of the first embodiment, or when an advertisement is presented and used by utilizing a message screen when power is turned off as in the case of the second embodiment, an advertisement used leads to a result having no bearing on an operation performed by the user (execution of an operation (first embodiment) or turning off power (second embodiment)). On the other hand, in this embodiment, only a change (a home page first displayed by a browser set by the user is replaced with the advertiser's home page) is made in the operation performed by the user (connection to the Internet 4). An advertisement can be used without disturbing the user's intention for operation.

### Fourth Embodiment

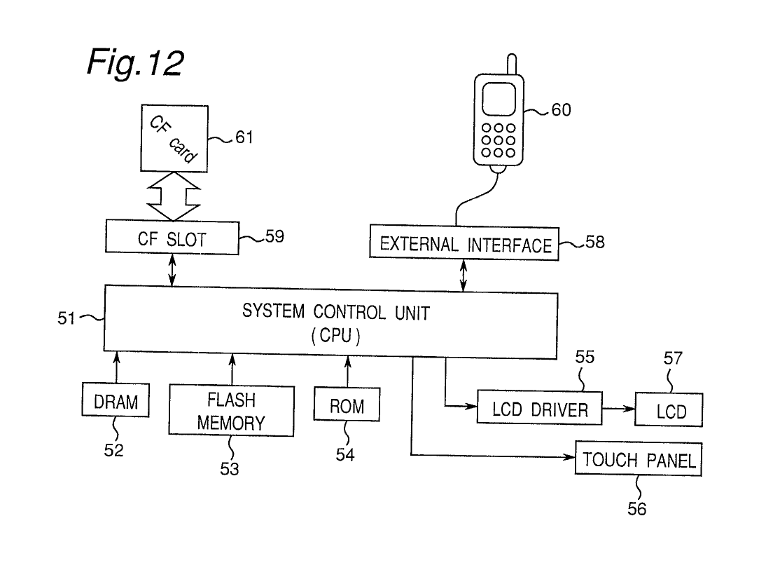

The fourth embodiment relates to an example of a hardware constitution of the information terminal device 1 shown in FIG. 1. FIG. 12 is a block diagram showing an example of a hard ware constitution of the information terminal device 1.

In FIG. 12, a system control unit 51 realized by a CPU (Central Processing Unit) displays advertisement information, other image and/or text information supplied from an information supplying device 3 on an LCD (Liquid Crystal Display) 57 based on a control program and display data supplied from a ROM (Read Only Memory) 54, flash memory 53 or CF (Compact Flash) card 61 described later.

A user interface constituted by the display transition button 24, confirmation button 26, advertisement image or the like is also displayed. When the user touches the display transition button 24, confirmation button 26 or advertisement image displayed on the LCD 57, this is detected via a touch panel 56. The user operation is acquired and a processing depending on the operation is performed.

Furthermore, various peripheral devices connected to an external interface 58 are controlled so that various processings such as connection to the Internet 4 and the like are performed. Various devices inserted into a CF slot 59 are also recognized and controlled. For example, a device such as a CF card 61 or the like is used as a secondary storage device according to various control programs.

A DRAM (Dynamic Random Access Memory) 52 has an area used as a work area when various control programs are executed.

The flash memory 53 is a section in which such rewritable information unique to the information terminal device 1 as identification information, setting information, user data and the like is stored and has a function of storing a control program saved in a ROM 54 described later, a control program for replacing data to be displayed or the like and display data. These control programs and display data are supplied from the CF card 61 recognized by the information terminal device 1 via the CF slot 59. Or, these programs can also be acquired via the Internet 4.

A control program for displaying the advertisement information and detecting and saving the advertisement use information is saved in the ROM 54. Furthermore, a control program for controlling an external interface 58 to control a portable phone, PHS or the like as a radiocommunication interface, a control program for connecting to the information collecting device 2 to send advertisement use information or the like, a control program for connecting to the information supplying device 3 to receive a supply of advertisement information, a minimum control program required for connecting to the Internet 4, other application programs, various data and the like are saved in the ROM 54.

An LCD driver 55 is controlled by the system control unit 51 and drives the LCD 57 to display an image and present information to a user. In this embodiment, a touch panel 56 integrally constituted on the LCD 57 has a function of receiving an input from the user. The user input can be received as if characters or an image displayed on the LCD 57 were directly operated.

The external interface 58 is an interface for connecting the information terminal device 1 and the peripheral devices. In FIG. 12, a portable phone 60 is connected as an example. The portable phone 60 secures the connection with the Internet 4 or the like according to the control by the system control unit 51 based on a control program saved in the ROM 54.

The CF slot 59 is an interface with an external storing medium and is not only used as another memory area for saving data in the flash memory 53 but also utilized to exchange data with other information terminal devices.

That is, in this embodiment, the system control unit 51 constitutes the advertisement presenting unit 6 and the advertisement using unit 7 in the information terminal device 1 shown in FIG. 1. The flash memory 53, ROM 54 or CF card 61 constitutes the advertisement information saving unit 5 and the advertisement use information storing unit 8. The external interface 58 and the portable phone 60 constitute the advertisement use information sending unit 11 and the advertisement information acquiring unit 12. The LCD driver 55, touch panel 56 and LCD 57 constitute the display device 9.

### Fifth Embodiment

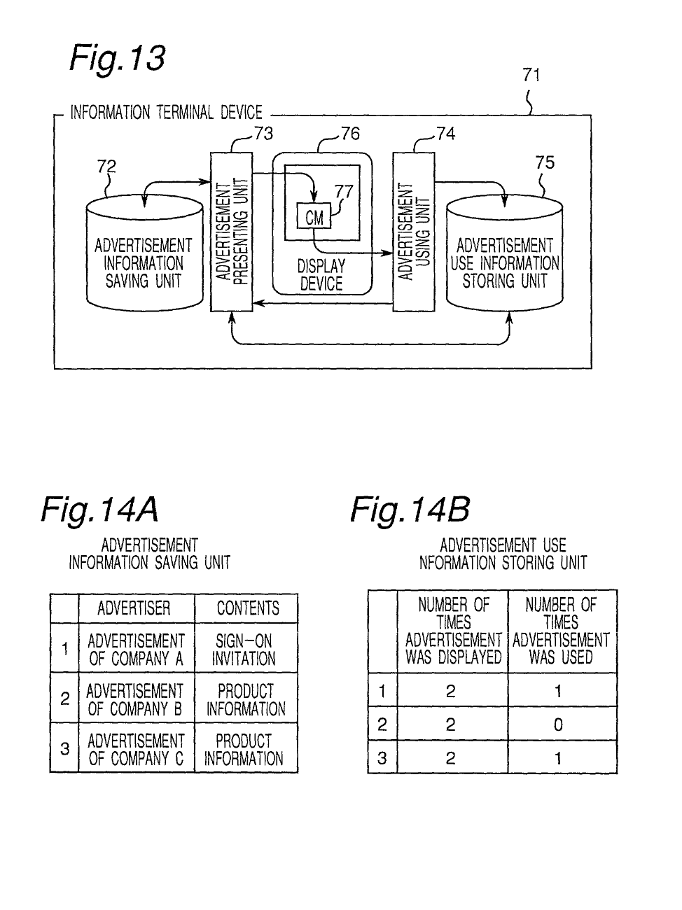

The fifth embodiment relates to an information processing device different from the information communication system shown in FIG. 1. FIG. 13 is a block diagram showing an example of a functional constitution of an information terminal device 71 as the information processing device. This information terminal device 71 does not require connection to a telecommunication network such as the Internet or the like to present an advertisement based on advertisement use information.

The information terminal device 71 is constituted by an advertisement information saving unit 72, advertisement presenting unit 73, advertisement using unit 74, advertisement use information storing unit 75 and display device 76.

The advertisement information saving unit 72 is a section in which advertisement information to be presented to a user is saved and corresponds to the advertisement information saving means. Here, contents of advertisement information are not particularly defined, but one example is shown later. Methods of storing advertisement information in the advertisement information saving unit 72 include setting the information in the advertisement information saving unit 72 in advance at the time of shipment, downloading the information from a personal computer, and the like.

The advertisement presenting unit 73 is a section for displaying the advertisement information saved in the advertisement information saving unit 72 in the display device 76 and corresponds to the advertisement information presenting means. A timing of outputting an advertisement, a size of an area to display the advertisement, a given time period and the like are obtained from the advertisement information read from the advertisement information saving unit 72. Depending on these obtained conditions, advertisement information reflecting a user's interest is selected and displayed on the display device 76 by utilizing advertisement use information stored in the advertisement use information storing unit 75. In FIG. 13, an advertisement is displayed in an area 77 in the display device 76.

The advertisement using unit 74 is a section for achieving a user interaction with an advertisement displayed in the display device 76 and detecting a user operation in response to the advertisement and corresponds to the advertisement using means. Here, a user operation detected by the advertisement using unit 74 is possible only by displaying an advertisement. Therefore, when the user performs this operation, it is judged that the user shows an interest in the presented advertisement. When a few kinds of operations are made possible, the intensity of the user's interest can be measured by checking which operation is performed.

The advertisement use information storing unit 75 is a section for storing a degree of a user's interest in the advertisement detected by the advertisement using unit 74 and corresponds to the advertisement use information storing means.

As is apparent from the above constitution, the information terminal device 71 can operate even in a state that the device is not connected to a telecommunication network such as the Internet or the like (offline state). The advertisement information can be displayed and information on a degree of the user's interest in the advertisement can be collected in this state.

FIG. 14 shows data constitution examples in the advertisement information saving unit 72 and the advertisement use information storing unit 75. In this example, advertisement information of three companies A, B and C is saved in the advertisement information saving unit 72. The numbers of times the advertisement was displayed and used are stored as advertisement use information in the advertisement use information storing unit 75. In this case, advertisements of all the three companies are presented twice each. The advertisements of companies A and C are used once. How the advertisement presenting unit 73 functions with the data constitution described above is described below.

As a specific strategy employed when the advertisement presenting unit 73 selects advertisement information to be presented next by utilizing the advertisement use information, the following strategy is employed, for example. That is, as shown in an equation below, an evaluation value is defined as a value obtained by subtracting ½ of the number of times an advertisement was used from the number of times the advertisement was displayed. Out of advertisement information having the smallest evaluation value, the advertisement information saved at a position closest to the first position in the advertisement information saving unit 72 (title number “1” in FIG. 14A) is selected.

Evaluation value=number of times advertisement was displayed−(number of times advertisement is used/2)

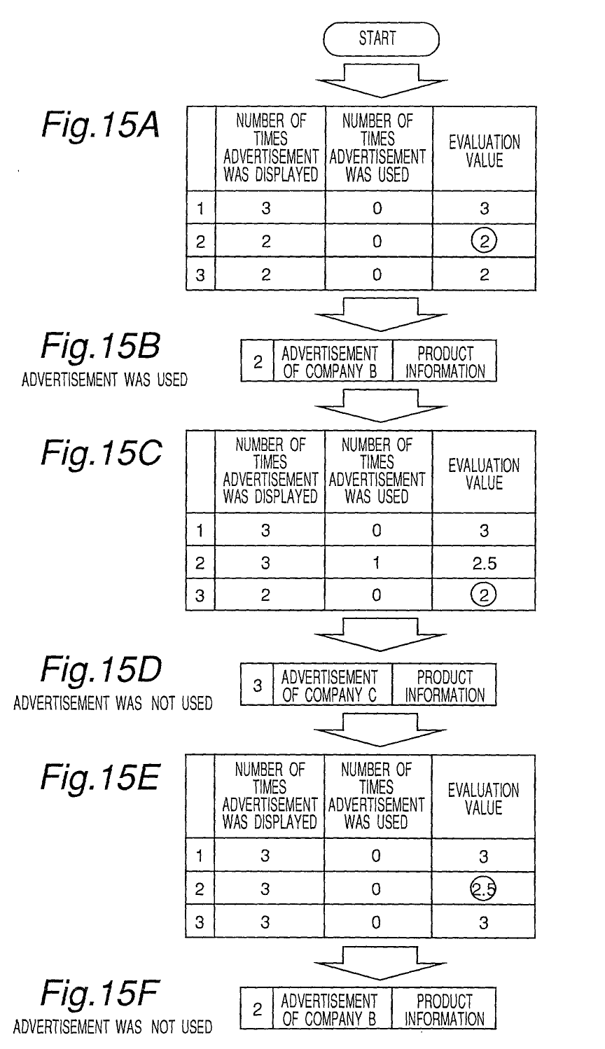

FIG. 15 shows contents of the advertisement use information storing unit 75 when an advertisement is presented based on the above described strategy for selecting the advertisement information, contents of displayed advertisement and whether the advertisement was used. Like title numbers used in FIGS. 14A and 14B are used. “1” represents company A, “2” represents company B and “3” represents company C.

FIG. 15A shows an initial state in the advertisement use information storing unit 75. The advertisements are displayed twice each sequentially from the advertisement of company A until this state. Then, the advertisement of company A is presented for the third time. Subsequently, the advertisement of company B is displayed since the evaluation value is “2”, the smallest value, and the title number is “2”, the smallest number.

FIG. 15B shows that the advertisement of company B was presented according to the above-described strategy. Here, it is assumed that the advertisement of company B was used.

FIG. 15C shows contents of the advertisement use information storing unit 75 in the state of FIG. 15B.

The number of times the advertisement of company B was displayed becomes 3. The increase to 1 in the number of times the advertisement of company B was used is shown. As a result, the evaluation value for the advertisement of company B is “2.5”. Subsequently, the advertisement of company C is displayed since the evaluation value is “2”, the smallest value.

FIG. 15D shows that the advertisement of company C was presented according to the above-described strategy. Here, it is assumed that the advertisement was not used.

FIG. 15E shows contents of the advertisement use information storing unit 75 in the state of FIG. 15D. The number of times the advertisement of company C was displayed becomes 3, showing that the third display of the advertisement was completed. As a result, the evaluation value for the advertisement of company C is “3”. Here, if an advertisement to be displayed is selected without considering the number of times the advertisement was used, the fourth display of the advertisements is started and the advertisement of company A is displayed. In this embodiment, however, the evaluation value is calculated in consideration to the number of times an advertisement is used. Therefore, the advertisement of company B is displayed next since the evaluation value is “2.5”, the smallest value.

FIG. 15F shows that the advertisement of company B was presented according to the strategy. Thus, the advertisement of company B, in which the user is interested, is displayed with a priority.

As described above, in this embodiment, the information terminal device 71 includes the advertisement presenting unit 73 and the advertisement using unit 74. Advertisement information saved in the advertisement information saving unit 72 is read and displayed in the display device 76 by the advertisement presenting unit 73. When a user uses the advertisement, advertisement use information is detected and stored in the advertisement use information storing unit 75 by the advertisement using unit 74.

At the next presentation of the advertisement, the advertisement presenting unit 73 determines an advertisement to be presented next based on the strategy determined reflecting the number of times the advertisement is used by referencing the advertisement use information accumulated in the advertisement use information storing unit 75. The determined advertisement information is read from the advertisement information saving unit 72 and displayed in the display device 76.

As a result, an advertisement on an area or a company in which a user is interested is displayed with a priority. Thus, advertising activities meeting user needs can be performed.

Although a simple strategy is exemplified in this embodiment as a strategy for selecting an advertisement information to be presented next, effectiveness of this embodiment can be understood. In this embodiment, the same advertisements are presented at all times, but the number of presented advertisements can be increased when a plurality of advertisements of various companies are saved in the advertisement information saving unit 72 as in the case of the first embodiment.

As in the case of the first embodiment, the advertisement use information sending unit can be provided and connected to a telecommunication network such as the Internet or the like so that the advertisement use information stored in the advertisement use information storing unit 75 can be sent to external information collecting devices.

Furthermore, presenting methods in the first and second embodiments can be employed although a method of presenting an advertisement in the display device 76 is not described. That is, methods are not particularly limited as long as they are not presenting methods utilizing a telecommunication network such as the method described in the third embodiment.

In the first to third embodiments, when pressing of the display transition button 24, 33, 34 or touch of the advertisement itself is detected, the display is immediately switched to detailed information. However, when a user is busy, there are cases where the user does not press the display transition button 24, 33, 34 or touch the advertisement itself even if the user is interested in the presented advertisement. To respond to these cases, a service (application) related to the presented advertisement can be reserved. When the specified condition (for example, at a certain time) is satisfied, the service can be executed.

As a result, the advertiser's home page information related to the presented advertisement is reserved so as to be acquired in a batch later. This is executed by connecting to the Internet 4 while the user is asleep. After a certain period of time, the Internet 4 is disconnected and detailed information can be browsed solely by the information terminal device 1, 71.

The above can be realized as follows. A reserve button is displayed in an image of the presented advertisement image. When this reserve button is operated, a user interface for specifying an execution start condition is generated. By operating the user interface, the specified execution start condition is registered in execution start condition registering means. Satisfaction of the execution start condition is monitored by service executing means. When the condition is satisfied, execution of the service (application) is started.

Functions as the advertisement information displaying means, advertisement using means, advertisement use information sending means, advertisement information acquiring means, advertisement use information receiving means, advertisement use information collecting means, advertisement use information analyzing means and advertisement information supplying means in the above respective embodiments are realized by an advertisement information presenting/updating and advertisement use information collecting program recorded in a program recording medium. The program recording medium in the above respective embodiments is a program medium constituted by a flash memory 53, ROM 54 or the like in FIG. 12. Or, a CF card 61 may be used as a program medium mounted and read in a CF slot 59 as an external auxiliary storage device. In any case, program reading means for reading the advertisement information presenting/updating and advertisement use information collecting program from the program medium may have a constitution of directly accessing the program medium and reading the program. Or, the program may be downloaded in a program storing area (not shown) provided in the flash memory 53 and then the program storing area can be accessed to read the program. It is assumed that a download program for downloading the program from the program medium to the program storing area in the flash memory 53 is saved in the system unit in advance.

Here, the program medium is constituted separatably from the system unit. Program media for carrying programs in a fixed manner include tapes such as a magnetic tape, cassette tape or the like, discs such as a magnetic disc such as a floppy disc, hard disc or the like and optical discs such as a CD (Compact Disc)-ROM, MO (Magneto-Optical) disc, MD (Mini Disc), DVD (Digital Video Disc) or the like, cards such as an IC (Integrated Circuit) card, optical card or the like and a semiconductor memory such as a mask ROM, EPROM (Erasable and Programmable ROM), EEPROM (electrically erasable programmable ROM), flash ROM or the like.

The information terminal device 1 in the first and fourth embodiments is provided with an external interface 58 and constituted such that the device can be connected to a telecommunication network including the Internet 4. Therefore, the program media may be carrying a program in a flexible manner by downloading from a telecommunication network or the like. It is assumed that a download program for downloading a program from the telecommunication network in this case is saved in the system unit in advance. Or, the program is installed from another recording medium.

Those recorded in the recording medium is not limited to programs, but data can also be recorded.

As is apparent from the above, the information communication system according to the first aspect of the invention displays advertisement information in the display means by the advertisement presenting means in the information terminal device in an offline state, in which the device is not connected to communication means. When a user operation by a user interface generated upon display of an advertisement or any other user operation during the display of the advertisement is detected by the advertisement using means, a service based on the displayed advertisement is instructed. Since advertisement use information indicating the use situation of the displayed advertisement is stored in the advertisement use information storing means, advertisement use information, which is information on a customer who is interested in the presented advertisement and good customer information, the use of which is expected for sales promotion, can be obtained.

Furthermore, the advertisement use information stored as described above is sent to the information collecting device by the advertisement use information sending means via the communication means in an online state. Since the advertisement use information received by the advertisement use information receiving means in the information collecting device is collected in the advertisement use information collecting means, the advertisement use information, which is good customer information, generated at this time can be collected as a trigger for guiding a user to a service related to the advertisement information saved in the information terminal device. Therefore, sales can be promoted by effectively using the advertisement use information.

Services based on the displayed advertisement include presentation of a contact number, access to a home page of the information provider (advertiser) via the communication means and the like in addition to the presentation of detailed information.

The information terminal device according to the second aspect of the invention displays advertisement information in the display means by the advertisement presenting means in the information terminal device in an offline state, in which the device is not connected to communication means. When a user operation by a user interface generated upon display of an advertisement or any other user operation during the display of the advertisement is detected by the advertisement using means, a service based on the displayed advertisement is instructed. Since advertisement use information indicating the use situation of the displayed advertisement is stored in the advertisement use information storing means, advertisement use information, which is information on a customer who is interested in the presented advertisement and very useful customer information showing the user's preference can be obtained.

Furthermore, since the advertisement use information stored as described above is sent to external devices by the advertisement use information sending means via the communication means in an online state, the advertiser can find prospective customers by utilizing advertisement use information (customer information) and lead this to sales promotion. Since the display frequency and the use frequency of an advertisement can be obtained, a provider of an advertisement medium can set, for example, an advertising rate for the advertiser based on the above information. Furthermore, this medium can be distinguished from other advertisement media since an indicator for measuring usefulness of advertisements can be obtained. The user can receive advertisements meeting the user's preference since the preference is reflected.

Services based on the displayed advertisement include presentation of a contact number, access to a home page of the information provider (advertiser) via the communication means and the like in addition to the presentation of detailed information.

The program recording medium according to the third aspect of the invention records an advertisement information presenting and advertisement use information collecting program for allowing a computer to function as the advertisement information saving means, advertisement presenting means, advertisement using means, advertisement use information storing means and advertisement use information sending means. Therefore, this medium can present advertisement information to a user. When a user operation by a user interface generated upon display of an advertisement or any other user operation during the display of the advertisement is detected, a service based on the displayed advertisement can be instructed. Furthermore, advertisement use information indicating the use situation of the displayed advertisement can be stored in the advertisement use information storing means. The stored advertisement use information can be sent to external devices via the communication means.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An information communication system including an information terminal device and an information collecting device capable of exchanging information therebetween via communication means, wherein
the information terminal device comprising:
advertisement information saving means for saving advertisement information;
display means;
advertisement presenting means for displaying the saved advertisement information on the display means;
advertisement using means for detecting a user operation by a user interface occurring upon display of an advertisement or any other user operation during the display of the advertisement, instructing a service based on the displayed advertisement and outputting advertisement use information indicating a use situation of the displayed advertisement;
advertisement use information storing means for storing the advertisement use information; and
advertisement use information sending means which is connected to the communication means and sends the stored advertisement use information to the information collecting device via the communication means; and wherein
the information collecting device comprising:
advertisement use information receiving means which is connected to the communication means and receives the advertisement use information sent from the information terminal device via the communication means; and
advertisement use information collecting means for collecting the received advertisement use information;
the information communication system, and wherein
the advertisement information saving means, advertisement presenting means, advertisement using means and advertisement use information storing means in the information terminal device can operate even in a state that the advertisement use information sending means is not connected to the communication means.

2. The information communication system according to claim 1 including an information supplying device capable of exchanging information with the information terminal device via the communication means; wherein
the information supplying device is connected to the communication means and has advertisement information supplying means for sending advertisement information to the information terminal device via the communication means; and
the information terminal device is connected to the communication means and has advertisement information acquiring means for receiving advertisement information sent from the advertisement information supplying means via the communication means.

3. The information communication system according to claim 2, wherein
the information collecting device and the information supplying device are mounted on the same equipment and directly exchange information with each other.

4. The information communication system according to claim 2, wherein
the information collecting device and the information supplying device exchange information with each other via the communication means.

5. The information communication system according to claim 3, wherein
the advertisement information acquiring means in the information terminal device sends a request for acquisition of advertisement information to the advertisement information supplying means in the information supplying device; and
the information supplying device receives the request for acquisition of advertisement information, analyzes advertisement use information collected by the information collecting device and has advertisement use information analyzing means for determining advertisement information to be sent to the information terminal device based on an analytical result.

6. The information communication system according to claim 4, wherein
the advertisement information acquiring means in the information terminal device sends a request for acquisition of advertisement information to the advertisement information supplying means in the information supplying device; and
the information supplying device receives the request for acquisition of advertisement information, analyzes advertisement use information collected by the information collecting device and has advertisement use information analyzing means for determining advertisement information to be sent to the information terminal device based on an analytical result.

7. An information terminal device capable of sending information via communication means comprising:
advertisement information saving means for saving advertisement information;
display means;
advertisement presenting means for displaying the saved advertisement information on the display means;
advertisement using means for detecting a user operation by a user interface occurring upon display of an advertisement or any other user operation during the display of the advertisement, instructing a service based on the displayed advertisement and outputting advertisement use information indicating a use situation of the displayed advertisement;
advertisement use information storing means for storing the advertisement use information; and
advertisement use information sending means which is connected to the communication means and sends the stored advertisement use information to external devices via the communication means; wherein
the advertisement information saving means, advertisement presenting means, advertisement using means and advertisement use information storing means can operate even in a state that the advertisement use information sending means is not connected to the communication means.

8. The information terminal device according to claim 7, wherein
the advertisement presenting means determines advertisement information to be displayed on the display means based on advertisement use information stored in the advertisement use information storing means.

9. The information terminal device according to claim 7 further comprising:
advertisement information acquiring means connected to the communication means for receiving advertisement information sent from an external device via the communication means.

10. The information terminal device according to claim 7, wherein
the advertisement presenting means displays an advertisement by utilizing part of a screen displayed on the display means for prompting a user for confirmation; and
a service instructed by the advertisement using means is changing contents of the display advertisement.

11. The information terminal device according to claim 7, wherein
the advertisement presenting means displays the advertisement when power is turned off; and
the advertisement using means suspends the turning off of the power to instruct the service.

12. The information terminal device according to claim 7, wherein
the advertisement presenting means displays an advertisement by utilizing part of a warning screen displayed on the display means when an application program is waiting for an operation; and
a service instructed by the advertisement using means is changing contents of the operation started immediately after the operation wait state finishes.

13. The information terminal device according to claim 7 comprising:
condition specifying means for specifying an execution start condition of the service instructed by the advertisement using means;
execution start condition registering means for registering the execution start condition specified by the condition specifying means when the user operation is detected by the advertisement using means; and
service executing means for monitoring satisfaction of the execution start condition registered in the execution start condition registering means and starting execution of the service when the condition is satisfied.

14. A program recording medium readable by a computer, wherein
an advertisement information presenting and advertisement use information collecting program for allowing a computer to function as the advertisement information saving means, advertisement presenting means, advertisement using means, advertisement use information storing means and advertisement use information sending means according to claim 1 is recorded.

15. A program recording medium readable by a computer, wherein
an advertisement information presenting and advertisement use information collecting program for allowing a computer to function as the advertisement information saving means, advertisement presenting means, advertisement using means, advertisement use information storing means and advertisement use information sending means according to claim 7 is recorded.
